(19) United States
(12) Patent Application Publication
(10) Pub. No.: US 2002/0085555 A1
(43) Pub. Date: Jul. 4, 2002

(54) Inter-processor communication method and apparatus for mobile communication system

(75) Inventor: Young Jun Jung, Gyunggi-do (KR)

Correspondence Address: FLESHNER & KIM, LLP, P.O. Box 221200, Chantilly, VA, 20153-1200, US

(73) Assignee: LG Electronics, Inc.

(21) Appl. No.: 10/029,150

(22) Filed: Dec. 31, 2001

(30) Foreign Application Priority Data
Dec. 30, 2000 (KR) 86587/2000

(51) Int. Cl. H04L 12/28

(52) U.S. Cl. 370/389

(57) ABSTRACT

An inter-processor communication method and apparatus for a mobile communication system are disclosed. Initially, a transmitting module receives a message transmission request from a connectionless-oriented user. The request includes a message and a destination address of the message. Next, the module determines whether any one of currently existing sockets, whose file descriptors are stored in a socket management database, is connected to the destination address. Finally, the module sends a connection request to a connection manager in order to be connected to a TCP layer if none of the existing sockets are connected to the destination address. As a result, a connectionless-oriented user is able to send/receive a message to/from another user using a transmission control protocol that provides connection-oriented data transmission services.

This application claims the benefit of the Korean Application No. P2000-86587 filed on Dec. 30, 2000, which is hereby incorporated by reference.

### BACKGROUND OF THE INVENTION

1. Field of the Invention

The present invention relates to a mobile communication system, and more particularly, to inter-processor communication method/apparatus for a communication system, in which a message is transmitted between the call-processing and maintenance processors without any connection management in an upper user layer.

2. Discussion of the Related Art

In general, a Transmission Control Protocol/Internet Protocol (TCP/IP) includes a network access layer, an internet layer, a transport layer, and an application layer. The transport layer includes a TCP that provides connection-oriented services and a User Datagram Protocol (UDP) that provides connectionless services.

The TCP that provides the connection-oriented services is responsible for managing data transmission processes between terminals, and it provides a data communication environment for communication entities of its upper layers. On the other hand, the UDP providing the connectionless services simply transmits each data packet to a corresponding destination address.

The TCP/IP layers being able to provide connection-oriented services are not embodied in the base stations and control stations of an existing mobile communication system. Therefore, a message gets transmitted using a packet-based message processing technique in a connectionless manner. Then, the network side performs a message routing process. For this reason, the existing mobile communication system uses a nonstandard protocol.

As described above, since each communication system uses an internal nonstandard protocol, it lacks the data transmission compatibility between data processors included in the system. In addition, the data handling processes related to the connectionless technique involve an additional data process for preventing any data loss, reducing the efficiency rate of the whole communication system.

### SUMMARY OF THE INVENTION

Accordingly, the present invention is directed to inter-processor communication method and apparatus for a mobile communication system that substantially obviates one or more problems due to limitations and disadvantages of the related art.

An object of the present invention is to provide inter-processor communication method and apparatus for a mobile communication system that enables a connectionless-oriented user to communicate with a connection-oriented data transmission system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an inter-processor communication method for a mobile communication system includes (a) receiving a message transmission request from a user, the request including a message and a destination address of the message; (b) determining whether any one of currently existing sockets, whose file descriptors are stored in a socket management database, is connected to the destination address; and (c) sending a connection request to a connection manager in order to be connected to a TCP (transmission control protocol) layer, if it is determined that none of the existing sockets are connected to the destination address.

The method further includes creating a new socket connected to the destination address and attempting to be connected to the TCP layer; storing a new file descriptor of the new socket in the database if the attempt is succeeded; and of newly forming a receiving module for the new socket.

In another aspect of the present invention, an inter-processor communication apparatus for a mobile communication system includes a socket management database storing file descriptors of currently existing sockets; a message-transmitting module receiving a message transmission request from a user, the request including a message and a destination address of the message, the module further sending a connection request in order to be connected to a TCP (transmission control protocol) layer if none of the existing sockets are connected to the destination address; and a connection manager creating a new socket connected to the destination address and attempting to connect the module with the TCP layer after receiving the connection request from the module.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates the interface layers of a communication system according to the present invention; and

FIG. 2 illustrates the functional blocks of the TCP message router according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The Transmission Control Protocol (TCP) message router according to the present invention includes a network equipment for routing a standard TCP/IP packet, an operating system (OS) that includes a standard TCP/IP protocol, a TCP/IP connection manager, and message transmitting and receiving modules.

The network equipment can be any one of an Asynchronous Transfer Mode (ATM) switch, an ATM user connecting system, a fast Ethernet hub, and workstations/embedded systems/PCs that include a fast Ethernet hub.

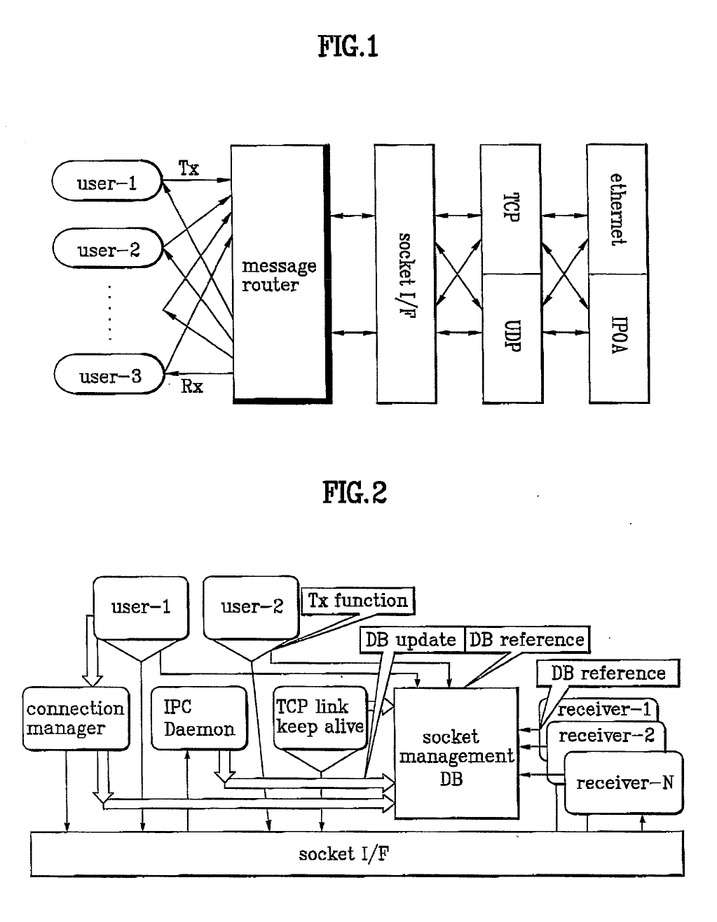

FIG. 1 illustrates the interface layers of a communication system according to the present invention. As shown in FIG. 1, a TCP message router receives a stream-based message from a connectionless-oriented user and sends the message to a socket interface through a socket.

Then the socket interface (I/F) sends the message to a TCP or User Datagram Protocol (UDP) layer. The TCP or UDP layer formats the message into a protocol data unit (PDU) and sends the formatted PDU to a network through an Ethernet layer or the ATM based IP (IPOA) layer.

The method of processing the TCP/IP based messages in accordance with the present invention includes the steps of connecting a connectionless-oriented user to a connection-oriented TCP, transmitting the messages, and receiving messages. References to these steps will now be made in detail using FIG. 2, which illustrates the functional blocks of the TCP message router according to the present invention.

First of all, the message router establishes the connection between a connectionless-oriented user and a connection-oriented TCP interface. The TCP message router does not attempt to connect to the TCP interface unless it receives a message transmission request from a user.

When the TCP message router receives a message transmission request from a user, a transmitting module determines whether any one of currently existing sockets, whose file descriptors (FD) are stored in a socket management database, is connected to the destination address.

If there is, the transmitting module sends the message to a TCP layer. Otherwise, it makes a connection request to a connection manager included in the TCP message router and waits to receive a reply.

When the connection manager receives a connection request from the transmitting module, it creates a new socket and attempts to connect to the TCP layer. If the connection manager succeeds in connecting to the TCP layer, it adds the socket information of the new socket to the socket management database and newly installs a receiving module corresponding to the new socket.

However, if it fails to connect to the TCP layer, the connection manager waits until it receives a connection request from another user. In this case, the socket gets deleted automatically. If the connection manager fails to connect to the TCP layer in a given time, the transmitting module informs the user of the failure.

When the connection manager receives another connection request from outside, it checks whether there is a socket that uses the address of the communication object that made the request. If there is, the connection manager deletes the socket and creates a new socket.

In addition, when a connection cancellation request or error is made in any socket whose FD is included in the database, it automatically closes the socket and eliminates the socket FD from the database. At this time, the connection manager may open a UDP socket for packet transmission through a UDP.

The Inter-Processor Communication (IPC) Daemon shown in FIG. 2 is a functional element that automatically runs a background program for inter-processor communication, and the TCP link keep-alive block checks whether the TCP is linked properly. The IPC Daemon and TCP link block can update the socket management database alternately. However, more than two functional blocks may refer to the database at same time.

Second of all, the transmitting module performs the message transmission process. When the transmitting module receives a message transmission request from a user, the module determines whether any one of currently existing sockets, whose file descriptors are stored in a socket management database, is connected to the destination address. If there is, it sends the message to a TCP layer through the socket. Otherwise, it makes a connection request to the connection manager and waits for a reply. If the transmitting module fails to connect to the TCP layer in a given time, it informs the user of the failure.

A stream-based message handled by the TCP may not be transmitted at once, and there is no indication of the beginning of the message. Therefore, the TCP adds a message header that indicates the beginning of the message to the message. The message header includes a message header indicator, a message length, a source address, a destination address, and a message Identifier (ID).

The transmitting module makes a transmission request by invoking a Service Access Function provided by the TCP. After the message is sent, the transmitting module receives the size of a portion of the message, which is actually sent. Subsequently, it sends the remaining portion of the message.

If the transmitting module does not complete the message transmission in a given time, it reports the failure. In addition, in a case where an error occurs in the Service Access Function, the transmitting module closes the socket, and reports the error.

When the transmitting module wants to send a message through a particular UDP socket, it initially searches for the socket. If the socket does not exist, the transmitting module makes a connection request and transmits the data.

Finally, a receiving module receives a message sent by a user. Because the TCP handles the stream-based data, a message can be received in the form of one or more data subsets, or more than one messages can be received at once.

When the receiving module receives the data subsets of a message, it stores the subsets in a circular queue in an order they were received. Thereafter, the data subsets are converted to a single data packet, and the packet is transmitted to a corresponding user.

A receiving module gets formed when a socket is formed, and it gets deleted when the socket is closed.

Namely, if the receiving module reads the byte stream of a message in a socket, it stores the message in a circular queue. Thereafter, it searches for a message indicator. If it finds the message indicator, it checks whether the data stored in the circular queue correspond to the message size indicated in the message header. If it still needs to receive more data, it waits until any data is read in the socket.

After checking the message header, it checks whether the data body included in the header is read. If the reading is completed, the receiving module sends the message to a destination user through an internal IPC. Otherwise, it waits until the data reading is completed. By repeating the steps described above, the entire message can be transmitted to the destination user.

A receiving module gets formed for each socket. The receiving module receives a message through a socket and transmits the message to the user.

As described above, a mobile communication system that handles packet-based data is able to use a TCP/IP that handles stream-based data by using the method and apparatus of the present invention. Therefore, an independent message processing mechanism can be provided for each final user. The present invention may also be applied to an IMT-2000 system or all other IP systems.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An inter-processor communication method for a mobile communication system, the method comprising the steps of:
(a) receiving a message transmission request from a user, said request including a message and a destination address of said message;
(b) determining whether any one of currently existing sockets, whose file descriptors are stored in a socket management database, is connected to said destination address; and
(c) sending a connection request to a connection manager in order to be connected to a TCP (transmission control protocol) layer, if it is determined in the step (b) that none of said existing sockets are connected to said destination address.

2. The method of claim 1, further comprising the step of sending said message to said TCP layer if it is determined in the step (b) that any one of said existing sockets is connected to said destination address.

3. The method of claim 1, further comprising the steps of:
creating a new socket connected to said destination address and attempting to be connected to said TCP layer; and
storing a new file descriptor of said new socket in said database if said attempt is succeeded.

4. The method of claim 3, further comprising the step of newly forming a receiving module for said new socket.

5. The method of claim 1, wherein said user is connectionless-oriented.

6. The method of claim 1, further comprising the step of informing said user of an incomplete message transmission, if not connected to said TCP layer for a given period of time.

7. An inter-processor communication apparatus for a mobile communication system, the apparatus comprising:
a socket management database storing file descriptors of currently existing sockets;
a message-transmitting module receiving a message transmission request from a user, said request including a message and a destination address of said message, said module further sending a connection request in order to be connected to a TCP (transmission control protocol) layer if none of said existing sockets are connected to said destination address; and
a connection manager creating a new socket connected to said destination address and attempting to connect said module with said TCP layer after receiving said connection request from said module.

8. The apparatus of claim 7, wherein said module sends said message to said TCP layer if any one of said existing sockets is connected to said destination address.

9. The apparatus of claim 7, wherein said manager stores a new file descriptor of said new socket in said database if said attempt is succeeded.

10. The apparatus of claim 9, wherein said manager forms a receiving module after storing said new file descriptor.

11. The apparatus of claim 7, wherein said manager waits to receive another connection request if said attempt is not succeeded.

12. The apparatus of claim 7, wherein said module adds a message header to said message, said header including a message header indicator, a message length, a source address, said destination address, and a message identifier.

13. The apparatus of claim 12, wherein said module sends said message together with said header to said TCP layer using said new socket.

14. The apparatus of claim 7, wherein said user is connectionless-oriented.
